(19) United States
(12) Patent Application Publication
(10) Pub. No.: US 2013/0133040 A1
(43) Pub. Date: May 23, 2013

(54) SYSTEM AND METHOD FOR MANAGING AUTHORIZATION OF FUNCTIONS OF ELECTRONIC DEVICE

(71) Applicant: SI-QUAN CHEN, Tu-Cheng (TW)

(72) Inventor: SI-QUAN CHEN, Tu-Cheng (TW)

(73) Assignee: HON HAI PRECISION INDUSTRY CO., LTD., Tu-Cheng (TW)

(21) Appl. No.: 13/407,775

(22) Filed: Feb. 29, 2012

(30) Foreign Application Priority Data
Nov. 17, 2011 (TW) 100142001

(51) Int. Cl. G06F 21/20

(52) U.S. Cl. 726/4

(57) ABSTRACT

A system includes a base station, a number of electronic devices, and a server. The base station radiates wireless signal including a base station identifier for identifying the base station and an authorization code for setting authorization level for a function of the electronic device. The electronic device detects the wireless signal, determines the existence of a predetermined base station according to the base station identifier, analyzes the authorization code to determine the function and authorization represented by the authorization code, disables the determined function, receives user information in response to an authorization input, transmits the received user information to the server to retrieve the pre-set authorization level of the user of the electronic device, and enables the function in response to the authorization represented by the authorization code being equal or lower than the retrieved pre-set authorization level.

### BACKGROUND

1. Technical Field

The present disclosure relates to a system and method for managing authorization of functions of an electronic device.

2. Description of Related Art

A cell-phone may have some particular functions, such as a picture capturing function and a networking function, which can be used to obtain information and transmit information. If the authorizations of such functions are not secured and managed properly, confidential information or secrets may be leaked.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic, component diagram of a system for managing authorization of functions of an electronic device in accordance with an exemplary embodiment.

FIG. 2 is an analytical diagram of a wireless signal radiated by a base station included in the system of FIG. 1.

FIG. 3 is a block diagram of the electronic device included in the system of FIG. 1.

FIG. 4 is a flowchart of a method for managing authorization of functions of the electronic device of FIG. 1.

FIG. 5 is a flowchart of a method for determining a particular base station, in accordance with an exemplary embodiment.

### DETAILED DESCRIPTION

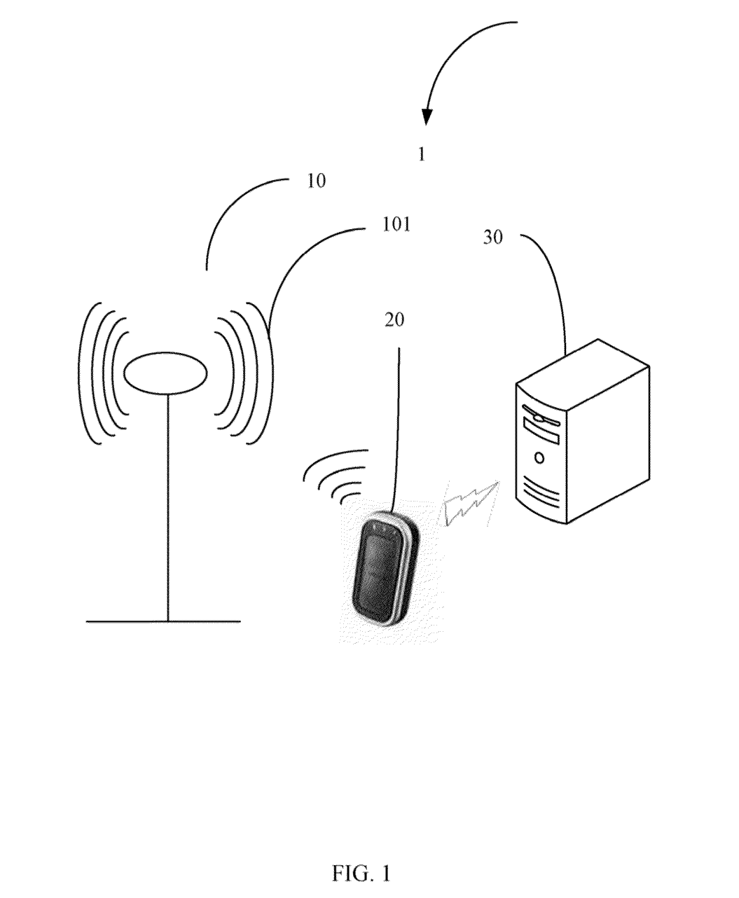

Referring to FIG. 1, a system includes a base station 10, an electronic device 20, and a server 30. The base station 10 radiates wireless signals 101. The electronic device 20 is capable of receiving the wireless signals 101 which are to initiate functions, such as a calling function and a networking function. The electronic device 10 is wirelessly connected to the server 30. In the embodiment, the base station 10 is a wireless fidelity (WiFi) base station. The electronic device 20 is a portable electronic device, such as a cell phone or a PDA.

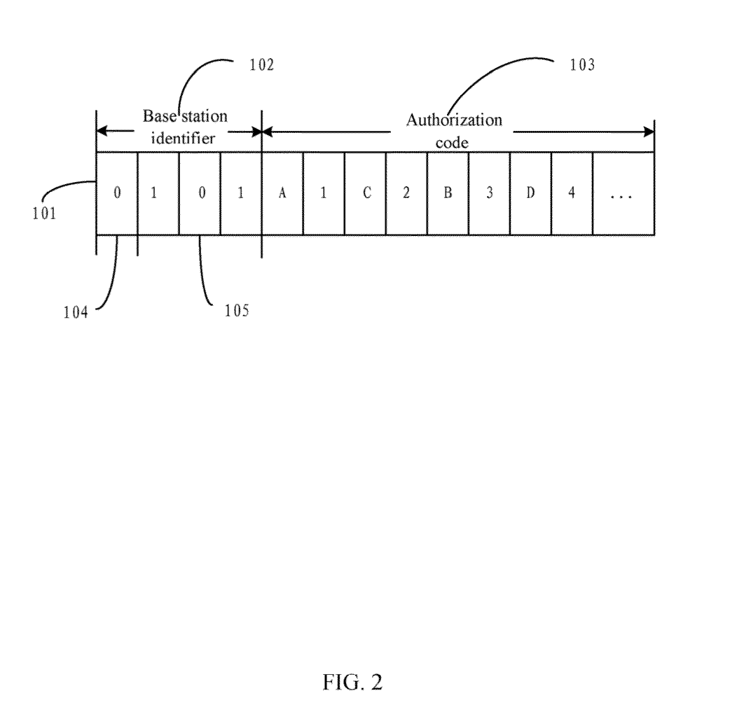

Referring to FIG. 2, the wireless signal 101 includes a base station identifier 102 and an authorization code 103. The base station identifier 102 is provided for the electronic device 20 to identify the base station 10. In the embodiment, the base station identifier 101 includes a simplified identifier 104 and a hardware identifier 105. The simplified identifier 104 is a short identifier to make the base station 10 rapidly recognizable by the electronic device 20. The hardware code 105 is a unique code for identifying the base station 10. The base stations 10 with the same simplified identifier 104 can be further distinguished and identified by the hardware code 105. The authorization code 103 presets authorization levels for some functions of the electronic device 20. The functions subject to any authorization can be used only when the authorization level of the electronic device 20 is higher or equal to the authorization level set for the function. In the embodiment, the authorization code 103 includes, but is not limited to, two codes. One of the two codes is used to represent a particular function of the electronic device 20 and the other of the two codes is used to represent the authorization level. In the exemplary embodiment, the one code is in a letter form, and the other code is in a number form. That is, letters are used to represent the functions of the electronic device 20 and numbers are used to represent the authorization levels. For example, A represents the calling function, B represents the picture capturing function, C represents the networking function, D represents the BLUETOOTH function; numbers 1, 2, 3 and 4 represent the authorization levels of the functions A, B, C, and D are respectively the first level, second level, third level, and fourth level authorizations. Accordingly, the authorization code A1 represents the calling function of the electronic device 20 and the calling function can then be used by an individual with an authorization level higher than the first level. The code C2 represents the networking function, which can be used by an individual with an authorization level higher than the second level.

The server 30 is for storing a server for storing a pre-set authorization level of user of the electronic device 20. In the embodiment, the authorization levels of the user of the electronic device 20 are preset and stored in table 1 as the example below shows. In the embodiment, the information as to authorization users (user information) is in the form of a user name and a password associated with the user name.

TABLE 1

| | User information | |
|---|---|---|
| Authorization level | User name | Password |
| 1 | Tom | XXXXX |
| | John | XXXXX |
| 2 | Alex | XXXXX |
| 3 | Stephen | XXXXX |
| | Mary | XXXXX |
| 4 | Linda | XXXXX |
| | Rose | XXXXX |

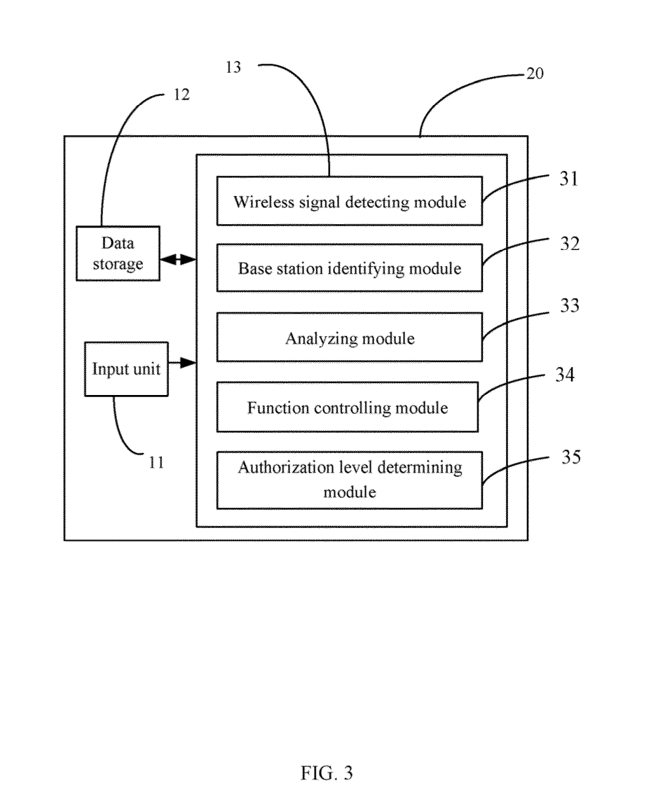

As shown in FIG. 3, the electronic device 10 includes a data storage 11, an input unit 12, and a processing unit 13. The processing unit 13 includes a wireless signal detecting module 31, a base station identifying module 32, an analyzing module 33, a function controlling module 34, and an authorization level obtaining module 35. The wireless signal detecting module 31 is for detecting the wireless signal 101 radiated from the base station 10, and storing the wireless signal 101 to the data storage 11. The base station identifying module 32 determines whether the base station 10 is a predetermined base station 10, according to a predetermined list of base stations 10, from which the signals need to be applied to management of the authorization functions of the electronic device 2, according to the base station identifier 102. In the embodiment, the base station identifying module 32 identifies whether the simplified identifiers 104 of the received wireless signals 101 are a predetermined simplified identifier. If the simplified identifiers 104 of the received wireless signals 101 are found to be not predetermined, the base station identifying module 32 determines that there is no predetermined base station 10. If there is at least one simplified identifier of the received wireless signals 101 found to be predetermined, the base station identifying module 32 further compares the hardware identifier 105 of the wireless signal with a predetermined hardware identifier 105 to finally determine whether the base station 10 is predetermined. The base station 10 radiating a wireless signal with the same hardware identifier 105 as the predetermined hardware identifier is established as a predetermined base station 10.

The analyzing module 33 analyzing the authorization code to determine the functions and authorizations represented by the authorization code. The function controlling module 34 disables the obtained function(s). The authorization level obtaining module 35 receives user information in response to an authorization input and transmits the received user information to the server to retrieve the pre-set authorization level of the user of the electronic device 20 by reference to Table 1. After the authorization level of the electronic device 20 is retrieved, the function controlling module 34 enables the functions in response to the authorization represented by the authorization code being equal or lower than the retrieved pre-set authorization level.

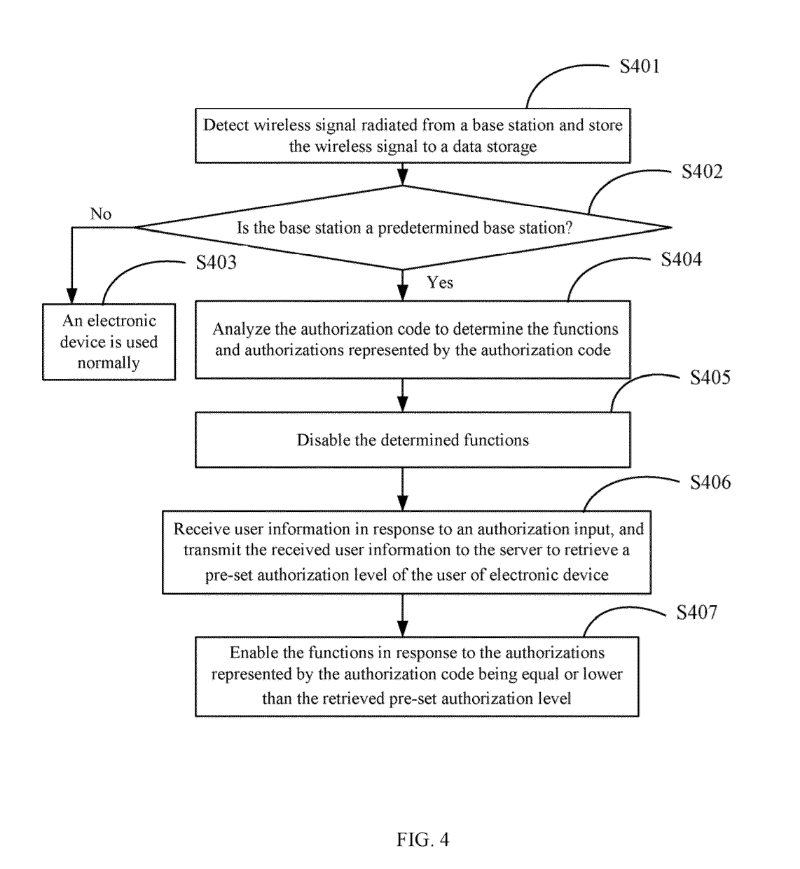

FIG. 4 is a flowchart of a method for securing and managing the functions of the electronic device of FIG. 1.

In step S401, the wireless signal detecting module 31 detects a wireless signal 101 radiated from the base station 10 and storing the wireless signal 101 to the data storage 11.

In step S402, the base station identifying module 32 determines whether the radiating base station is a predetermined base station 10.

If the radiating base station is not a predetermined base station 10, in step S403, the electronic device 20 is used normally.

If the base station 10 is found to be predetermined, in step S404, the analyzing module 33 analyzes the authorization code to determine the functions and authorizations represented by the authorization code 103.

In step S405, the function controlling module 34 disables the determined functions.

In step S406, the authorization level obtaining module 35 receives user information in response to an authorization input, and transmits the received user information to the server 30 to retrieve the pre-set authorization level of the user of electronic device 2.

In step S407, after the authorization level of the user of the electronic device 2 is determined, the function controlling module 34 enables the functions in response to the authorizations represented by the authorization code 103 being equal or lower than the retrieved pre-set authorization level.

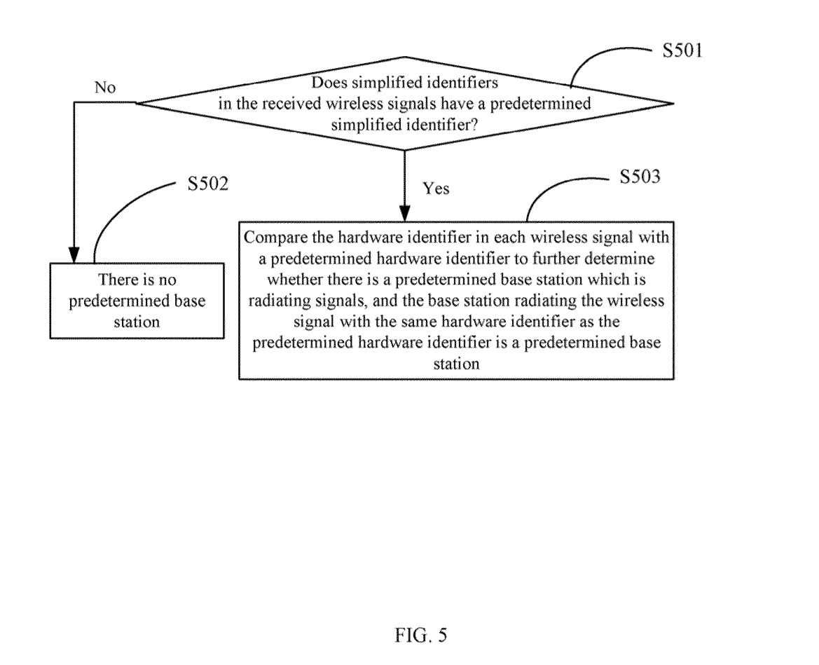

FIG. 5 is a flowchart of a method for the base station identifying module 32 to determine whether a radiating base station is a predetermined base station, as employed in step S402 of FIG. 4.

In step S501, the base station identifying module 32 identifies whether the simplified identifiers 104 in the received wireless signals 101 have a predetermined simplified identifier.

In step S502, if no simplified identifier 104 identical to a predetermined simplified identifier can be found in all the wireless signals 101, the base station identifying module determines that there is no predetermined base station.

In step S503, if there is at least one simplified identifier found to be identical to a predetermined simplified identifier, the base station identifying module 32 further compares the hardware identifier 105 in each wireless signal with a predetermined hardware identifier 105 to further determine whether there is a predetermined base station which is radiating signals, and the base station 10 radiating the wireless signal with the same hardware identifier 105 as the predetermined hardware identifier is a predetermined base station 10.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A system comprising:
an electronic device;
a base station to radiate a wireless signal, wherein the wireless signal comprises a base station identifier for identifying the base station and an authorization code pre-set an authorization level for a function of the electronic device; a server for storing a pre-set authorization level of user of the electronic device;
wherein the electronic device comprises:
a wireless signal detecting module for detecting the wireless signal radiated from the base station;
a base station identifying module for determining whether the base station is a predetermined base station according to the base station identifier;
an analyzing module for analyzing the authorization code to determine the function and authorization represented by the authorization code;
a function controlling module for disabling the determined function;
an authorization level obtaining module for receiving user information in response to an authorization input, and transmitting the received user information to the server to retrieve the pre-set authorization level of the user of the electronic device;
wherein the function controlling module enables the function in response to the authorization represented by the authorization code being equal or lower than the retrieved pre-set authorization level.

2. The system as described in claim 1, wherein the base station identifier comprises a simplified identifier and a hardware identifier, the simplified identifier is a short identifier to make the base station rapidly recognizable by the electronic device, the hardware code is a unique code for identifying the base station, when determining whether the base station is the predetermined base station, the base station identifying module identifies whether the simplified identifiers of the received wireless signals are a predetermined simplified identifier, if the simplified identifiers of the received wireless signals are found to be not predetermined, the base station identifying module determines that there is no predetermined base station, if there is at least one simplified identifier of the received wireless signals is predetermined, the base station identifying module further compares the hardware identifier of the wireless signal with a predetermined hardware identifier to further determine whether the base station is predetermined, and the base station radiating the wireless signal with the same hardware identifier as the predetermined hardware identifier is a predetermined base station.

3. The system as described in claim 1, wherein the authorization code comprises two codes, one of the two codes is used to represent a particular function of the electronic device and the other of the two codes is used to represent the authorization level.

4. The system as described in claim 3, wherein letters are used to represent the functions of the electronic device and numbers are used to represent the authorization levels.

5. The system as described in claim 1, wherein the authorization level of the electronic device stored in the server is predetermined by a user information of a user using the electronic device, when determining the authorization level of the electronic device, the authorization level obtaining module receives the user information in response to an authorizing input, and transmits the received user information to the server to determine authorization level of the electronic device.

6. A method for managing authorization of functions of electronic device, comprising:
detecting wireless signal radiated from a base station, wherein the wireless signal comprises a base station identifier for identifying the base station and an authorization code preset authorization level for a function of the electronic device;
determining whether the base station is a predetermined base station according to the base station identifier;
analyzing the authorization code to determine the function and authorization represented by the authorization code;
disabling the determined functions;
receiving user information in response to an authorization input and transmitting the received user information to the server to retrieve the pre-set authorization level of the user of the electronic device;
enabling the function in response to the authorization represented by the authorization code being equal or lower than the retrieved pre-set authorization level.

7. The method as described in claim 6, wherein the base station identifier comprises a simplified identifier and a hardware identifier, the simplified identifier is a short identifier to make the base station rapidly recognizable by the electronic device, the hardware code is a unique code for identifying the base station, the step for determining whether the base station is the predetermined base station comprising: identifying whether the simplified identifiers of the received wireless signals are a predetermined simplified identifier; determining that there is no predetermined base station if the simplified identifier of the received wireless signal are not predetermined, comparing the hardware identifier of the wireless signal with a predetermined hardware identifier to further determine whether the base station is predetermined if there is at least one simplified identifier of the received wireless signals found to be predetermined, and determining the base station radiating the wireless signal with the same hardware identifier as the predetermined hardware identifier is a predetermined base station.

8. The method as described in claim 6, wherein the authorization code comprises two codes, one of the two codes is used to represent a particular function of the electronic device and the other of the two codes is used to represent the authorization level.

9. The method as described in claim 8, wherein letters are used to represent the functions of the electronic device and numbers are used to represent the authorization levels.

10. The method as described in claim 6, wherein the authorization level of the electronic device stored in the server is predetermined by a user information of a user using the electronic device, the step for determining the authorization level of the electronic device further comprising receiving the user information in response to an authorizing input, and transmitting the received user information to the server to determine authorization level of the electronic device.
